(19) United States
(12) Patent Application Publication
(10) Pub. No.: US 2008/0283719 A1
(43) Pub. Date: Nov. 20, 2008

(54) Wall Protector

(75) Inventors: James W. Lowry, Franklin, TN (US); Erik W. Rogers, Murfreesboro, TN (US)

Correspondence Address: CLAUSEN MILLER, P.C, SUITE 1600, 10S. LASALLE STREET, CHICAGO, IL, 60603, US

(73) Assignee: SONOCO DEVELOPMENT, INC., Hartsville, SC (US)

(21) Appl. No.: 11/750,410

(22) Filed: May 18, 2007

(51) Int. Cl. F16M 13/02

(52) U.S. Cl. 248/615; 248/205.3

(57) ABSTRACT

A protector for protecting a wall or other flat building surface from impacts caused by people and equipment. The protector is made from paper and comprises a honeycomb layer sandwiched between a wall-facing, lightweight paper layer and an outer-facing, heavyweight paperboard layer. The three-layer construction with a heavyweight paperboard outer layer is capable of distributing a point load across the entire surface area of the protector. The protector can be affixed to and removed from a wall without damaging or marking the wall.

### BACKGROUND

1. Field of the Invention

This patent relates to a device for protecting flat building surfaces such as a wall during construction, renovation or moving. More particularly, this patent relates to a wall protective device that can be easily installed and removed afterwards without damaging or leaving any marks on the wall.

2. Description of the Related Art

During construction, renovation and moving operations key surfaces in a building, especially those in high traffic areas, can be subjected to abuse by workers and equipment moving in and around the building rooms. These surfaces, include door frames, door edges, corners and flat surfaces such as walls, are costly to repair and can delay the completion of a building project. Protecting these surfaces avoids these costly repairs, reduces overall building costs and shortens building project time.

It is an object of the present invention to provide a means for protecting flat building surfaces such as walls that are vulnerable to abuse by workers and equipment during construction, renovation or moving.

Another object of the invention is to provide a wall protective device that can be easily and quickly installed and removed.

Still another object of the invention is to provide a protective device for a wall surface that does not leave marks when removed.

Further and additional objects will appear from the description, accompanying drawings, and appended claims.

### SUMMARY OF THE INVENTION

The present invention is a device for protecting a wall from impacts caused by people and equipment. The device is made from paper and comprises a honeycomb layer interposed between a wall-facing, lightweight paper layer and an outer-facing, heavyweight paperboard layer.

The honeycomb layer preferably is about one inch thick and comprises cells that run transversely between the inner and outer layers to provide transverse cushioning and impact resistance. The cells can be any suitable cross sectional shape, including but not limited to pentagonal and hexagonal.

The wall-facing, lightweight paper layer is made of paper having a lighter weight than the paper used to make the outer-facing, heavyweight paperboard layer. Both layers are bonded to the honeycomb cells by adhesive.

The three-layer construction is capable of distributing a point load across the entire surface area of the wall protector. The protector can be affixed to and removed from a wall without damaging or marking the wall.

### THE DRAWINGS

FIG. 1 is a perspective view of a wall protector made according to the present invention.

FIG. 2 is a perspective view of the opposite, wall-facing side of the wall protector of FIG. 1.

FIG. 3 is a perspective view of the wall protector of FIG. 1 shown protecting a wall.

FIG. 4 is a perspective view of a corner of the wall protector of FIG. 1 showing the layers of the wall protector.

### DETAILED DESCRIPTION OF THE INVENTION

While this invention may be embodied in many forms, there is shown in the drawings and will herein be described in detail one or more embodiments, with the understanding that this disclosure is to be considered an exemplification of the principles of the invention and is not intended to limit the invention to the illustrated embodiments.

For the purposes of the following description, the term “paper” used in the general sense refers to any kind of fiber sheet formed from vegetable material, including wood and wood pulp. The term “paper” used in the specific sense refers to one of the two broad subdivisions of paper (general sense), the other subdivision being paperboard. The distinction between paper (specific sense) and paperboard is not sharp, but for the purpose of this description paperboard is heavier, thicker and more rigid than paper (specific sense).

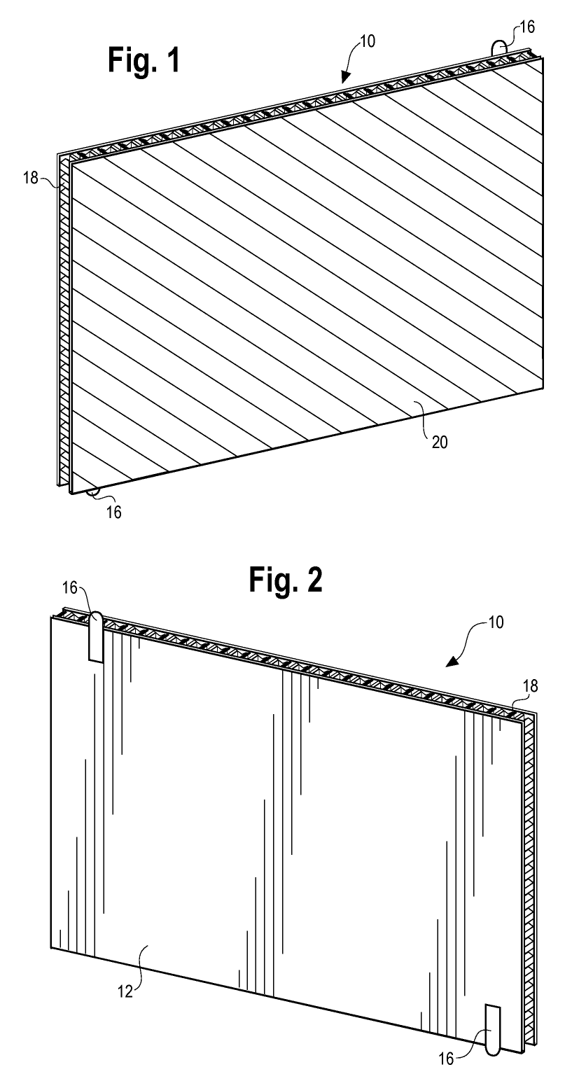

Turning to the drawings, there is shown in FIGS. 1-4 one embodiment of the present invention, a wall protector 10 for protecting a wall or other flat building surface from impacts and abrasions during construction, renovation and moving operations. The protector 10 comprises a honeycomb layer 18 sandwiched between a wall-facing, lightweight paper layer 12 and an outer-facing, heavyweight paperboard layer 14.

A brightly or prominently marked outer-facing label 20 may be bonded to the outer-facing side of the heavyweight paperboard layer 14.

The honeycomb layer 18 preferably is about one inch thick and comprised entirely of paper. As perhaps best shown in FIG. 4, the honeycomb cells run transversely between the inner and outer layers 12, 14 to provide transverse cushioning and impact resistance. The cells can be any suitable cross sectional shape, including but not limited to pentagonal and hexagonal.

The wall-facing, lightweight paper layer 12 is made of paper having a lighter weight than the outer-facing, heavyweight paperboard layer 14, and is bonded to the honeycomb cells by adhesive.

The outer-facing heavyweight paper layer 14 is made from relatively heavier weight paperboard, and is bonded to the outer-facing ends of the honeycomb cells by adhesive.

The wall protector 10 may be removably affixed to the wall by any suitable attachment means, with adhesive tabs 16 being preferred. The adhesive tabs 16 preferably are affixed to two diagonally opposite corners of the lightweight paper layer 12, but may be located in other positions.

Preferably the adhesive tabs 16 have a foam middle layer sandwiched between layers made from tacky, pressure sensitive adhesive, like the adhesive tabs described in U.S. Pat. No. 6,231,962 and sold under the brand name Command Strips™ by 3M Company. Releasable backings cover the adhesive until the tabs 16 are ready for use. The adhesive tabs 16 enable the wall protector 10 to be affixed to and removed from a wall without damaging the wall.

The wall protector 10 is adhered to a wall or other flat surface by first removing the releasable backings from one side of the tabs 16, adhering the exposed adhesive side of the tabs 16 to the lightweight paper layer 12, removing the wall-side releasable backings from the tabs 16, and pressing the adhesive tabs against the wall or other flat surface.

Alternatively, the adhesive tabs 16 may be affixed to a layer other than the lightweight paper layer 12, such as the heavyweight paperboard layer 14 or the optional outer-facing label 20. The tabs 16 must extend beyond the perimeter of the wall protector 10 so that they can reach the wall to secure the wall protector 10 thereto.

In another alternative embodiment, tacky, pressure sensitive adhesive can be applied directly to the wall-facing, lightweight, paper layer 12 and covered with a releasable backing until ready for use.

The optional outer-facing label 20 is also held in place by adhesive. The outer-facing label 20 may be brightly colored in, say, a black and yellow pattern, or otherwise marked with attention-getting text or graphics to warn workers and others against bumping or knocking against the protected area.

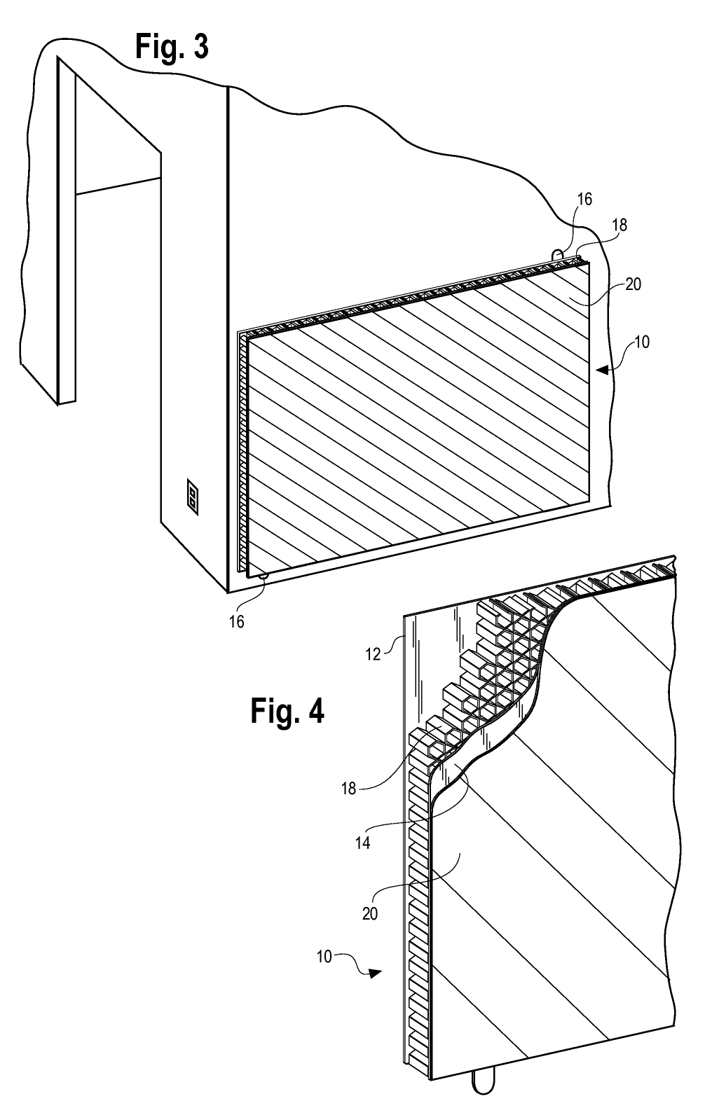

FIG. 3 is a perspective view of the wall protector 10 shown installed on a wall near a wall edge. The wall protector 10 covers the wall at an area that is most likely to be subject to abuse from people and equipment. The wall protector 10 can be made any size to cover as much of the wall as desired, and can even be cut on site as needed. A typical protector is 18″ by 24″, although they may be made to any desirable dimensions.

A surprising advantage of the wall protector's three layer construction is that it distributes a point load across the entire surface area of the protector 10. Except in very extreme cases, a point impact against the outer layer 14 will not damage the wall being protected.

The lightweight, all paper construction allows the protector 10 to be affixed to a wall with a minimum of adhesion, thereby allowing for the use of removable adhesive tabs 16.

Thus there has been described a device that provides protection to an exposed drywall, wood interior wall or other flat surface from impact, abrasion and incidental damage. The device is made entirely from bonded paper and comprises a honeycomb middle layer interposed between flat paper layers. The outer-facing layer is made from relatively heavier paper than the wall-facing layer to better distribute a point load across the entire surface area of the device. The device may be affixed to and removed from a wall without damaging or marking the wall.

It is understood that the embodiments of the invention described above are only particular examples which serve to illustrate the principles of the invention. Modifications and alternative embodiments of the invention are contemplated which do not depart from the scope of the invention as defined by the foregoing teachings and appended claims. It is intended that the claims cover all such modifications and alternative embodiments that fall within their scope.

We claim as our invention:

1. A protector for protecting a flat building surface, the protector comprising:
a honeycomb layer interposed between a lightweight paper layer and a heavyweight paperboard layer, the honeycomb layer being made from paper and having a wall-facing side and an outer side, the lightweight, paper layer being bonded to the wall-facing side of the honeycomb layer and the heavyweight paperboard layer being bonded to the outer side of the honeycomb layer, the honeycomb layer comprising cells that run transversely between the lightweight paper layer and the heavyweight paperboard layer; and
means for attaching the protector to the flat building surface.

2. The protector of claim 1 wherein the attaching means comprises at least one adhesive tab affixed to the lightweight paper layer for removably affixing the protector to the flat building surface.

3. The protector of claim 1 further comprising an outer-facing label bonded to a side of the heavyweight paperboard layer away from the honeycomb layer, the outer-facing label being marked in an attention getting manner.

4. The protector of claim 1 wherein the honeycomb layer is about one inch thick.

5. The protector of claim 1 wherein the honeycomb layer comprises cells having a hexagonal cross sectional shape.

6. The protector of claim 1 wherein the lightweight paper layer is made paper having a lighter weight than the outer-facing, heavyweight paperboard layer.

7. The protector of claim 2 wherein the at least one adhesive tab 16 has a middle layer interposed between layers of tacky, pressure sensitive adhesive.

8. The protector of claim 7 wherein the protector may be affixed to and removed from the flat building surface without damaging the flat building surface.

9. The protector of claim 1 wherein the protector is at least eighteen inches high and twenty-four inches wide.

10. The protector of claim 7 wherein adhesive tabs are affixed to two diagonally opposite corners of the lightweight paper layer.

11. The protector of claim 1 wherein the attachment means comprises tacky, pressure sensitive adhesive disposed on the side of the lightweight, paper layer away from the honeycomb layer for removably affixing the protector to the flat building surface.

12. The protector of claim 11 wherein the tacky, pressure sensitive adhesive is covered by a releasable backing until ready for use.
